(19) United States
(12) Patent Application Publication
(10) Pub. No.: US 2023/0150512 A1
(43) Pub. Date: May 18, 2023

(54) METHODS AND SYSTEMS FOR PROVIDING ESCALATION BASED RESPONSES

(71) Applicant: Motional AD LLC, Boston, MA (US)

(72) Inventors: Moira DOHERTY, Charlestown, MA (US); Jacob KREMER, Jamaica Plain, MA (US); William LU, Somerville, MA (US)

(21) Appl. No.: 17/524,785

(22) Filed: Nov. 12, 2021

(51) Int. Cl. B60W 40/08; G07C 5/08; B60W 60/00; B60W 50/14; B60W 30/14

(52) U.S. Cl. CPC B60W 40/08; G07C 5/08; B60W 60/001; B60W 50/14; B60W 30/143; B60W 2540/227; B60W 2050/146; B60W 2420/42; B60W 2040/0881

(57) ABSTRACT

Provided are methods for providing escalation based responses, which can include obtaining sensor data and determining whether the data satisfies at least one of one or more criteria. Some methods described also include determining a violation parameter and/or a response indicative of an escalation of a policy violation. Systems and computer program products are also provided.

### TECHNICAL FIELD

The present disclosure relates generally to methods and systems for escalation based responses.

### BACKGROUND

Vehicles may include policies for passengers to follow when traveling, ranging from safety-related policies (e.g., don't tamper with the sensors) to operational policies (e.g., no food or drink in the vehicle). In non-autonomous vehicle, the driver is responsible for enforcing these policies, but in an autonomous vehicle there is no human to detect when a passenger has infringed on any given policy.

### BRIEF DESCRIPTION OF THE FIGURES

FIG. 1 is an example environment in which a vehicle including one or more components of an autonomous system can be implemented;

FIG. 2 is a diagram of one or more systems of a vehicle including an autonomous system;

FIG. 3 is a diagram of components of one or more devices and/or one or more systems of FIGS. 1 and 2;

FIG. 4 is a diagram of certain components of an autonomous system;

FIG. 5 is a diagram of an example implementation of a process for providing escalation based responses;

FIGS. 6A-6C are diagrams of example implementations of a process for providing escalation based responses;

FIG. 7 is a flowchart of an example process for providing escalation based responses; and

FIG. 8 is a signal processing diagram of an example process for providing escalation based responses.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology fused in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

“At least one,” and “one or more” includes a function being performed by one element, a function being performed by more than one element, e.g., in a distributed fashion, several functions being performed by one element, several functions being performed by several elements, or any combination of the above.”

Some embodiments of the present disclosure are described herein in connection with a threshold. As described herein, satisfying a threshold can refer to a value being greater than the threshold, more than the threshold, higher than the threshold, greater than or equal to the threshold, less than the threshold, fewer than the threshold, lower than the threshold, less than or equal to the threshold, equal to the threshold, and/or the like.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

General Overview

In some aspects and/or embodiments, systems, methods, and computer program products described herein include and/or implement an escalation-based response, for example of an autonomous vehicle. Specifically, described herein are systems, methods, and computer program products for obtaining sensor data associated with an autonomous vehicle and determining responses to the sensor data, such as one or more escalations of responses.

By virtue of the implementation of systems, methods, and computer program products described herein, disclosed are techniques for providing a differentiated response to policy violations. The techniques may enable the autonomous vehicle to make automatic determinations on the correct course of action, which can effectively triage issues. The techniques can enable a scalable solution that does not rely entirely on human monitoring and intervention. By virtue of implementation of certain techniques described herein, autonomous vehicles (AVs) can benefit from an improved operation, an improved maintenance of integrity, and an improved safety. The techniques can enable an optimized response for policy violations. By virtue of implementation of certain techniques described herein, autonomous vehicles (AVs) can benefit from an improved speed of processing policy violation.

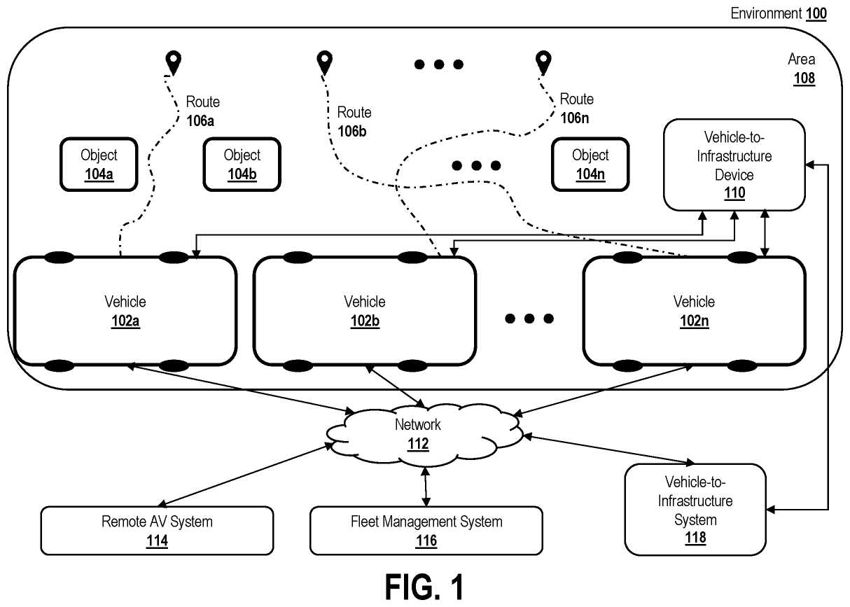

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

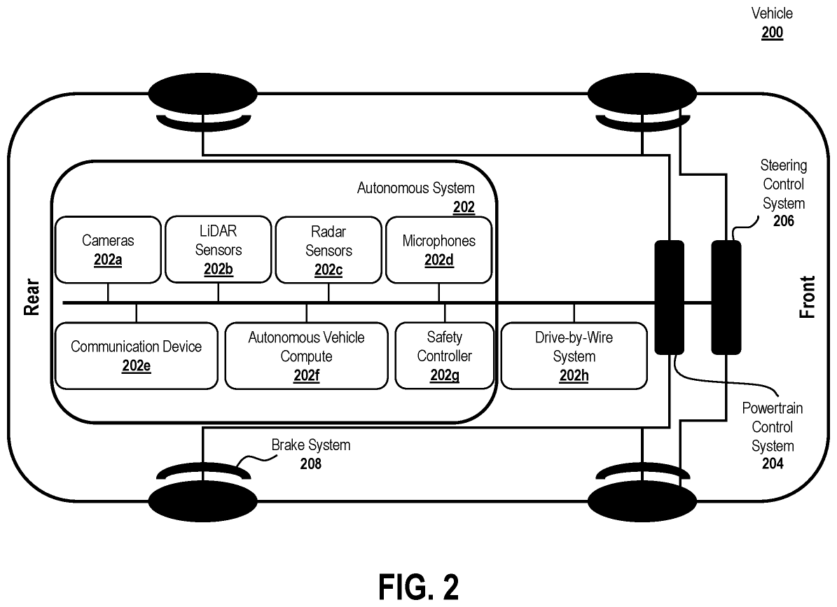

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and ends at a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure or Vehicle-to-Everything (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 includes autonomous system 202, powertrain control system 204, steering control system 206, and brake system 208. In some embodiments, vehicle 200 is the same as or similar to vehicle 102 (see FIG. 1). In some embodiments, vehicle 200 has autonomous capability (e.g., implement at least one function, feature, device, and/or the like that enable vehicle 200 to be partially or fully operated without human intervention including, without limitation, fully autonomous vehicles (e.g., vehicles that forego reliance on human intervention), highly autonomous vehicles (e.g., vehicles that forego reliance on human intervention in certain situations), and/or the like). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, and safety controller 202g.

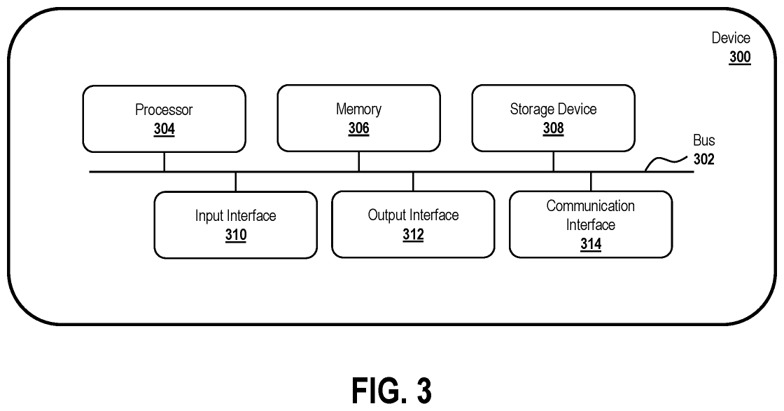

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a charge-coupled device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Laser Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e include at least one device configured to be in communication with cameras 202a, LiDAR sensors 202b, radar sensors 202c, microphones 202d, autonomous vehicle compute 202f, safety controller 202g, and/or DBW system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like) a server (e.g., a computing device including one or more central processing units, graphical processing units, and/or the like), and/or the like. In some embodiments, autonomous vehicle compute 202f is the same as or similar to autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to start moving forward, stop moving forward, start moving backward, stop moving backward, accelerate in a direction, decelerate in a direction, perform a left turn, perform a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102), at least one device of remote AV system 114, fleet management system 116, V2I system 118, and/or one or more devices of network 112 (e.g., one or more devices of a system of network 112). In some embodiments, one or more devices of vehicles 102 (e.g., one or more devices of a system of vehicles 102 such as at least one device of remote AV system 114, fleet management system 116, and V2I system 118, and/or one or more devices of network 112 (e.g., one or more devices of a system of network 112) include at least one device 300 and/or at least one component of device 300. As shown in FIG. 3, device 300 includes bus 302, processor 304, memory 306, storage component 308, input interface 310, output interface 312, and communication interface 314.

Bus 302 includes a component that permits communication among the components of device 300. In some embodiments, processor 304 is implemented in hardware, software, or a combination of hardware and software. In some examples, processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a Wi-Fi® interface, a cellular network interface, and/or the like.

In some embodiments, device 300 performs one or more processes described herein. Device 300 performs these processes based on processor 304 executing software instructions stored by a computer-readable medium, such as memory 305 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

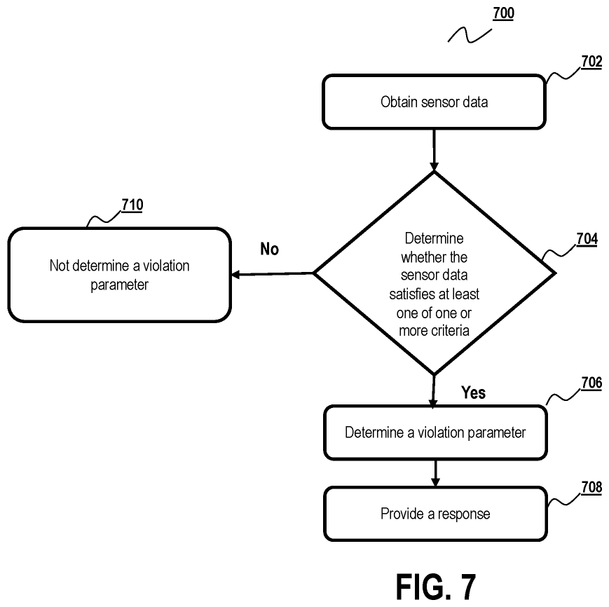

In some embodiments, device 300 is configured to execute software instructions of one or more steps of the disclosed method, as illustrated in FIG. 7.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

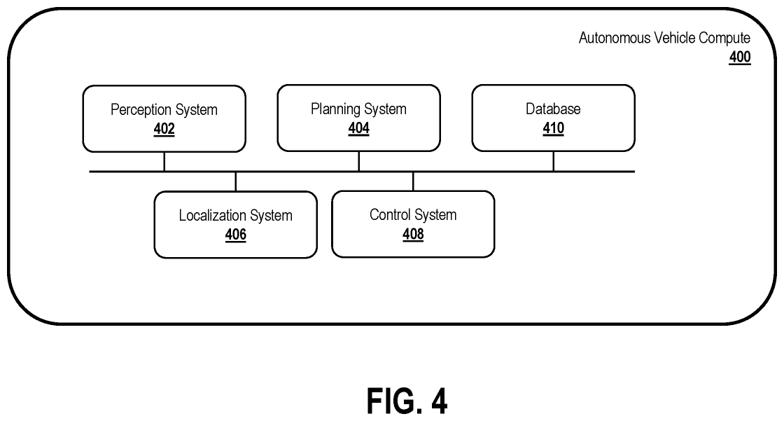

Referring now to FIG. 4, illustrated is an example block diagram of an autonomous vehicle compute 400 (sometimes referred to as an “AV stack”). As illustrated, autonomous vehicle compute 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits [ASICs], Field Programmable Gate Arrays (FPGAs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like).

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

In some embodiments, implementation 500 includes an AV compute 540, and a vehicle (similar to vehicle 200 of FIG. 2, such as an autonomous vehicle). In some embodiments, system 500 is the same as or like system, such as a remote AV system, a fleet management system, and/or a V2I system.

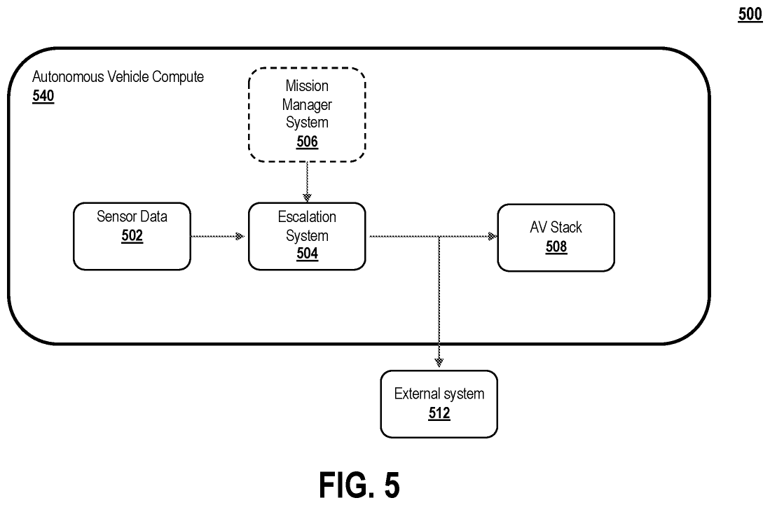

Referring now to FIG. 5, illustrated is a diagram of an implementation, such as a system, 500 of a process for providing escalation-based responses. In some embodiments, implementation 500 includes an AV compute 540, and a vehicle (similar to vehicle 200 of FIG. 2, such as an autonomous vehicle). In some embodiments, implementation 500 is the same as or like system, such as an AV (e.g. illustrated in FIGS. 2, 3 and 4), an AV system, a remote AV system, a fleet management system, and/or a V2I system. The implementation 500, such as the system, can be for operating an autonomous vehicle. The implementation 500, such as the system, may not be for operating an autonomous vehicle.

Advantageously, disclosed herein are systems, methods, and computer program products that can provide for scalable policy infringement detection and/or escalation. As an example, an autonomous vehicle may have a number of stored policies that a passenger would be required to follow for use of the autonomous vehicle, such as onboard the AV. The systems, methods, and computer program products disclosed herein can determine whether a policy violation by a passenger has occurred, such as using one or more sensors, and then provide an appropriate response to the policy violation. Further, the systems, methods, and computer program products can provide for escalation of the response, such as if the passenger is continuing with the policy violation and/or if the passenger violates an additional policy. Such an escalation may occur a number of times until the policy violation has been resolved.

In one or more implementations, such as for an autonomous vehicle, as an autonomous vehicle may not have a human operator, such as a driver, it may be advantageous to detect violation(s), such as infringement(s), of policy. It may further be advantageous to escalate, in particular appropriately escalate, responses to such policy violations. The responses can be escalated any number of times, and can continue with either communication from a customer service agent (CSA) and/or causing minimum risk maneuvers (MRM) to occur in the autonomous vehicle if the policy violation is not rectified. Severe policy violations may lead directly to minimum risk maneuvers or communication from a customer service agents. For example, severe policy violations may skip certain responses.

Advantageously, sensor data, such as from vehicle sensors and/or cabin monitoring systems, can be synergistically combined with decision making, such as rule-based decision making, for determinations on how to address and/or escalate responses based on a given policy violation. It may be envisaged that can be combined with the decision making which may be a machine learning decision making, and/or an artificial intelligence decision making. Responses can vary from auditory and/or light-based communication, to device notifications either of the passenger or the vehicle. Other responses can be performed as well.

Disclosed herein is a system, such as system 500 of FIG. 5. The system 500 can include at least one processor. The system 500 can include an escalation system 504 and an autonomous vehicle (AV) stack 508 and optionally a mission manager system 506. The autonomous vehicle (AV) stack 508 may be seen as an AV compute, and/or a part of the AV compute, such as AV compute 540.

The system 500 can include at least one memory storing instructions thereon that, when executed by the at least one processor, cause the at least one processor to obtain sensor data sensor data 502 associated with an autonomous vehicle. The system 500 can include at least one memory storing instructions thereon that, when executed by the at least one processor, cause the at least one processor to determine whether the sensor data 502 satisfies at least one of one or more criteria. The system 500 can include at least one memory storing instructions thereon that, when executed by the at least one processor, cause the at least one processor to determine, based on the sensor data 502, a violation parameter indicative of a policy violation of the autonomous vehicle in response to determining that the sensor data 502 satisfies the at least one of the one or more criteria. The system 500 can include, at least one memory storing instructions thereon that, when executed by the at least one processor, cause the at least one processor to determine a violation parameter indicative of a policy violation of the autonomous vehicle in response to determining that the sensor data 502 satisfies the at least one of the one or more criteria. The system 500 can include at least one memory storing instructions thereon that, when executed by the at least one processor, cause the at least one processor to provide, based on the violation parameter, a response indicative of an escalation of the policy violation in response to determining that the sensor data 502 satisfies the at least one of the one or more criteria. The system 500 can include, at least one memory storing instructions thereon that, when executed by the at least one processor, cause the at least one processor to provide a response indicative of an escalation of the policy violation in response to determining that the sensor data 502 satisfies the at least one of the one or more criteria.

For example, the escalation system 504 can obtain the sensor data 502. For example, the escalation system 504 can determine whether the sensor data 502 satisfies at least one of one or more criteria. The one more criteria may be stored in a memory as part of the policy data. For example, the escalation system 504 can determine, based on the sensor data 502, a violation parameter indicative of a policy violation of the autonomous vehicle in response to determining that the sensor data 502 satisfies the at least one of the one or more criteria. For example, the escalation system 504 can provide, based on the violation parameter, a response indicative of an escalation of the policy violation. For example, the escalation system 504 can provide the response to the AV stack 508, and/or to an external system 512.

For example, the escalation system 504 can provide the response to the AV stack 508, for example to trigger an MRM, wherein the response is indicative of an MRM command. For example, the escalation system 504 can provide the response to the AV stack 508, for example to trigger an output of a notification to a passenger, on an output system of the AV. The output system may include a display system of the AV and/or a loudspeaker system of the AV.

For example, the escalation system 504 can provide the response to an external system 512, such as one or more of: a remote system (such as a remote customer assistance (RCA) system, and/or a passenger device (such as a portable device of a passenger).

The sensor data 502 can be obtained from one or more sensors. The sensor data 502 can be combined by the at least one processor. An autonomous vehicle may include one or more sensors that can be configured to monitor an environment where the AV operates. For example, the monitoring can provide sensor data 502 indicative of what is happening within and/or outside of the autonomous vehicle.

Example sensors that can be used can include sensors that may be included as standard in an automobile. Other sensors which may not be included as standard in an automobile can be used as well. The particular type of sensor is not limiting. The sensors, or systems associated with the sensors, can include methods for analysis of the sensor data 502. Certain sensors may work together for providing the sensor data 502. Advantageously, different sensor data 502 from different sensors can be combined (e.g. fused) for determination of policy violations and/or escalation. Sensors can include one or more of the sensors illustrated in FIG. 1.

A policy may be considered as information indicative one or more operational rules to follow in relation with operations of an AV. A policy may be in form of policy data indicative one or more operational rules or criteria to satisfy for operations of the AV in a satisfactory and/or safe manner. A policy may include one or more operational policies and/or one or more safety policies to ensure operation of the AV and/or integrity of the AV and/or passenger safety, and/or safety around the AV. A policy violation may be seen as a determination, based on sensor data 502, of one of more events that contravene one or more policies of operating the AV, e.g. for safety, integrity and/or maintenance of the AV.

A violation parameter may be seen as a parameter indicative of a policy violation, for example that occurs in relation to a vehicle, such as an AV. For example, the violation parameter can be a parameter that indicates a violation of a policy of the vehicle. For example, the violation parameter can be a parameter that indicates that a passenger violates a policy when the passenger is associated with the autonomous vehicle, such as based on an interaction inside and/or outside the autonomous vehicle. For example, the violation parameter can be a parameter that indicates if there is a policy violation or not, such as in form of a flag. For example, the violation parameter can be a parameter that indicates a corresponding policy violation and/or to a corresponding type of policy violations. For example, the violation parameter can be a parameter that enables a mapping to a corresponding policy violation and/or to a corresponding type of policy violations, which leads to a corresponding response. The violation parameter may be seen as violation data.

An escalation may be seen as increasing a level of reaction to a policy violation, for example ranging from a notification to a passenger to a more limited operation of the autonomous vehicle, such as an MRM.

The sensor data 502 can be obtained from one or more sensors associated with the autonomous vehicle. The one or more sensors can be seen as one or more sensors configured to monitor an environment of the AV, such as an environment that the AV is located in. For example, the one or more sensors can include one or more of: passenger occupancy detection system (PODS) sensors, optical sensors (such as cameras), infrared sensors, pressure sensors, seatbelt sensors, and cabin monitoring systems (CMS).

As an example, PODS sensors can detect when a someone or something is occupying a particular seat in a vehicle. Seatbelt sensors which can determine whether a seatbelt is buckled or not may also be an example sensor.

CMS can be used in conjunction with, or alternative to, one or more sensors in an autonomous vehicle. CMS can include one or more image sensors, such as cameras. CMS can include one or more processors which may process sensor data 502 received from the one or more image sensors, such as for determination of a policy violation. CMS may be considered as a vision-based sensor. The CMS may be able to extract information from its sensor data 502. For example, the CMS may be able to extract, such as detect, one or more of: positions, poses, and actions of passengers, or parts of passengers.

The sensor data 502 can be used to determine policy violations. For example, the autonomous vehicle may have policies, such as rules, guidelines, to regulate use of the autonomous vehicle. For example, the policies may be about a passenger behavior in the autonomous vehicle. For example, the policies can be intended to increase the safety of passengers and/or to ensure proper maintenance of the autonomous vehicle. The policies can be set into the autonomous vehicle. Machine learning can be used to add, modify, and/or update policies of the autonomous vehicle.

In one or more example systems, the sensor data 502 can be obtained from one or more of: a video-based cabin monitoring system, a seatbelt sensor, pose detection, and a seat occupancy sensor.

The sensor data 502 can be one or more of: optical sensor data, presence sensor data, thermal sensor data, image data, pressure data, weight data, conductivity data, and connection data. The particular type of sensor data 502 is not limiting.

In one or more example systems, the sensor data 502 can include sensor data internal to the autonomous vehicle.

For example, the sensor data 502 can be indicative of what is happening inside the autonomous vehicle. For example, the sensor data 502 can be indicative of a cabin of an autonomous vehicle.

In one or more example systems, the sensor data 502 can include sensor data external to the autonomous vehicle.

For example, the sensor data 502 may be indicative of actions happening outside of the autonomous vehicle, such as outside of the cabin of the autonomous vehicle. For example, the sensor data 502 may be indicative of a user extending a body part out of a window of the autonomous vehicle. Further, the sensor data 502 may be indicative of any blockage of sensors on an external of the autonomous vehicle.

The system 500 may obtain the sensor data 502 directly from one or more sensors. The system 500 may obtain the sensor data 502 indirectly from the one or more sensors. For example, the system 500 may obtain the sensor data 502 from a server and/or a memory. The server and/or memory may be a component of the autonomous vehicle. The server and/or memory may be separate from and in communication with the autonomous vehicle.

The sensor data 502 may be used for the determination of a violation parameter, such as indicative of a policy violation. For example, the sensor data 502 may be able to show whether a passenger is violating an autonomous vehicle policy. There may be any number of different types of policy violations. Policies, and their respective policy violations, can be added, removed, and/or modified. Policy data indicative of policy violation may be obtained by the system 500, for example from a memory and/or a remote database. Examples of policy violations can include any one of: having food or drink in a vehicle, having too many passengers in a vehicle, sitting improperly, not having a seat belt buckled, having body parts outside of a vehicle window, sitting in a driver's seat, and tampering with cameras and/or sensors. Other policy violations can be included, and the list of policy violations are merely exemplary. Policy data indicative of a policy violation may include policy data indicative any one of: having food or drink in a vehicle, having too many passengers in a vehicle, sitting improperly, not having a seat belt buckled, having body parts outside of a vehicle window, sitting in a driver's seat, and tampering with cameras and/or sensors. The policy data may include one or more criteria which when met indicate a policy violation.

In order to determine a violation parameter, the system 500 can use one or more criteria. For example, the system 500 may be configured to determine whether the sensor data 502 satisfies at least one of one or more criteria, such as one or more thresholds. The system 500 may include any number of criteria, in any number of combinations. For example, a cabin monitoring system may use a cabin monitoring vision algorithm to determine whether the sensor data 502 satisfies at least one of one or more criteria.

A satisfying of the one or more criteria can indicate a policy violation by a passenger. The system 500 may have any number of criteria, but satisfying any one of them may lead to a provision of a response. In one or more implementations, satisfying more than one of the criteria leads to a provision of a response.

The response can be determined by applying a set of rules indicated by the one or more criteria, and/or indicated by the violation parameter determined. For example, by referencing a pre-determined set of rules, the escalation software can determine that a specific violation requires a passenger notification but does not require further escalation or a minimum risk maneuver.

By virtue of the implementation of systems, methods, and computer program products described herein, disclosed are techniques for providing a differentiated response to policy violations. The techniques may enable the autonomous vehicle to make automatic determinations on the correct course of action, which can effectively triage issues. The techniques can enable a scalable solution that does not rely entirely on human monitoring and intervention. By virtue of implementation of certain techniques described herein, autonomous vehicles (AVs) can benefit from an improved operation, an improved maintenance of integrity, and an improved safety. The techniques can enable an optimized response for policy violations. By virtue of implementation of certain techniques described herein, autonomous vehicles (AVs) can benefit from an improved speed of processing policy violation.

The one or more criteria may include further parameters, thresholds, criteria, etc. The one or more criteria may include one or more of a first, second, third, fourth, fifth, or sixth criteria.

In one or more example systems, the one or more criteria may include a first criterion. The first criterion can be based on a time threshold.

The time threshold can be indicative of an amount of time that a policy is being violated to lead to a response. For example, the system 500 may not automatically provide a response as soon as a policy is violated. There may be some give, such as room, for a rectifying action to be taken before a response is given by the system 500. Alternatively, there may not be a time threshold and/or the time threshold can be set to 0 seconds.

As an example, it may take some time for a user to put on a seat belt when entering an autonomous vehicle. It may be advantageous to provide the passenger some time in order to put on a seat belt before providing a response indicative that the seat belt should be put on.

The time threshold can be, for example, 1, 2, 3, 4, 5, 10, 15, 20 seconds. The time threshold can be, for example, 1, 2, 3, 4, 5, 10, 15, 20 minutes. The time threshold may vary depending on the particular policy violation that is occurring.

As one example, the time threshold may be a threshold of a predetermined length of time after which the escalation software initiates a remote customer assistance (RCA) call due to an extended violation of this specific rule. The escalation system 504, such as escalation software, can continue to receive sensor data 502 from the cabin monitoring vision algorithm and seatbelt buckle sensors, and after a predetermined length of time, the escalation system 504 initiates an RCA call due to an extended violation of this specific rule.

For example, if a policy violation extends past the time threshold, the one or more criteria may be satisfied. If the policy violation ends before the time threshold, the one or more criteria may not be satisfied.

In one or more example systems, the one or more criteria can include a second criterion. The second criterion can be based on a threshold associated with a passenger number (e.g. the number of passengers).

For example, the second criterion can be based on a number of available seats in an autonomous vehicle. The threshold can be associated with the passenger number above which there is a policy violation. For example, the AV may be authorized to transport a number of passengers based on space and/or capacity of the AV, and/or based on a ride data. A policy violation, and a violation parameter is determined when the number of passenger is above the threshold. Depending on the size and space of an autonomous vehicle, this may be for example, a passenger number of 1, 2, 3, 4, 5, 6, 7, 8, 9, or 10. Accordingly, the processor can be configured to determine whether there are more passengers in the autonomous vehicle than there are available seats.

For example, if the sensor data 502 indicates that there are more passengers than the threshold associated with a passenger number, the second criterion may be satisfied, and thereby at least one of the one or more criteria may be satisfied. If the sensor data 502 indicates that there are less than or equal passengers than the threshold associated with a passenger number, the second criterion may not be satisfied.

In one or more example systems, the one or more criteria can include a third criterion. The third criterion can be based on sensor data 502 detecting an event indicative of a tampering of one or more sensors.

For example, sensor data 502 can detect a user blocking, such as covering, one or more sensors. The sensor data 502 can detect a user attempting to modify one or more sensors. For example, tampering can be tampering with internal cameras, and/or other sensors. The tampering may be determined by the sensor itself indicating that it is being tampered with. The tampering may be determined by the CMS indicating that a passenger is tampering with a different sensor.

For example, when it is determined based on the sensor data 502 that a passenger is tampering with one or more sensors, the third criterion may be satisfied, and thereby at least one of the one or more criteria may be satisfied. When it is determined that a passenger is not tampering with one or more sensors, the third criterion may not be satisfied.

In one or more example systems, the one or more criteria can include a fourth criterion. The fourth criterion can be based on sensor data 502 detecting a pose indicative of the policy violation of the autonomous vehicle.

For example, the sensor data 502 may detect a passenger not sitting upright, such as laying down. A pose may be a predefined pose, such as a pose indicating a passenger not sitting upright. The system may have pre-defined poses that are policy violations. The system may have pre-defined poses that are not policy violations.

For example, when the sensor data 502 indicates that a passenger is in a pose that is a policy violation, the fourth criterion may be satisfied, and thereby at least one of the one or more criteria may be satisfied. When the sensor data 502 indicates that a passenger is in a pose that is not a policy violation, the fourth criterion may not be satisfied.

In one or more example systems, the one or more criteria can include a fifth criterion, wherein the fifth criterion is based on sensor data 502 detecting a position of a passenger in the autonomous vehicle indicative of a policy violation. For example, the position of a passenger in the autonomous vehicle indicative of a policy violation may be a predefined position, such as a driver seat position.

For example, the sensor data 502 may detect a passenger sitting in the driver's seat instead of a passenger seat. A position may be a predefined position, such as a position indicating a passenger sitting in the driver's seat. The system may have pre-defined positions that are policy violations. The system may have pre-defined positions that are not policy violations.

For example, when the sensor data 502 indicates a passenger is in a position that is a policy violation, the fifth criterion may be satisfied, and thereby at least one of the one or more criteria may be satisfied. When the sensor data 502 indicates that a passenger is in a position that is not a policy violation, the fifth criterion may not be satisfied.

The one or more criteria can be any and/or all of the above criteria. The one or more criteria can include further criteria not discussed herein, and the above are merely explanatory.

In response to determining that the sensor data 502 does not satisfy the at least one of the one or more criteria, the at least one processor may take no action. In response to determining that the sensor data 502 does not satisfy the at least one of the one or more criteria, the at least one processor may not determine a violation parameter. In response to determining that the sensor data 502 does not satisfy the at least one of the one or more criteria, the at least one processor may not provide a response. For example, the autonomous vehicle may continue operating as normal.

In response to determining that the sensor data 502 does satisfy the at least one of the one or more criteria, a violation parameter indicative of a policy violation, such as a policy infringement, of the autonomous vehicle can be determined.

For example, when a determination is made that a passenger violates a policy, one or more actions can be taken. In one example, a violation parameter can be determined. The violation parameter may be indicative of a policy violation. This can help assure that a proper response and/or escalation are performed.

For example, the autonomous vehicle may have a set of policies, such as a set of rules, related to passenger safety and/or vehicle maintenance. A policy may include one or more operational policies and/or one or more safety policies to ensure operation of the autonomous vehicle and/or integrity of the autonomous vehicle and/or passenger safety, and/or safety around the autonomous vehicle. It may be advantageous to take certain actions based on a violation of such a policy. As policies may greatly vary, targeting a response to a particular violation may be advantageous.

In response to determining that the sensor data 502 does satisfy the at least one of the one or more criteria, a response can be provided. The response can be based on the violation parameter. For example, different responses can be taken based on the type of policy violation, such as based on the violation parameter.

The response can be determined by applying a set of rules indicated by the one or more criteria. The response can be determined by applying a set of rules indicated by violation parameter.

The response may be, for example, stored in a database. The response may be determined by machine learning. The response may be a physical response by the autonomous vehicle. The response may be an environmental response by the autonomous vehicle.

The response indicative of an escalation may be seen as increasing a level of reaction to policy violation, for example ranging from a notification to a passenger to a more limited operation of the autonomous vehicle. Referencing a pre-determined set of rules, the escalation software can determine that this specific violation requires a passenger notification but does not require further escalation or a minimum risk maneuver (MRM).

The response may be indicative of an escalation of the policy violation. The escalation can be an increase, a rise, an advance, a change, in a response.

An escalation may be from no response to a particular response. Alternatively, the escalation may be from a previous response to an updated response.

In one or more example systems, to provide the response indicative of the escalation of the policy violation can include to determine, based on the sensor data 502 and the violation parameter, the response. To provide the response indicative of the escalation of the policy violation can include to determine the response.

For example, the system can be configured to determine an appropriate response based on the policy violation, such as based on the violation parameter. The determination of the response can be based on a rule-based system. The determination of the response can be based on machine learning.

The mission manager system 506 can provide a phase of the operation. The phase of operation of the autonomous vehicle may be seen as a phase in a ride, such as a phase in a mission. For example the phase of the operation can indicate a phase before the start of an operation, such as of a ride and/or a mission. For example the phase of the operation can indicate a phase during an operation, such as a ride and/or a mission. For example the phase of the operation can indicate a phase after an operation, such as a ride and/or a mission. The phase of the operation may be a phase of current operation and/or a phase during which the violation occurred. Phases of operation can include one or more of: before starting the vehicle, prior to the vehicle operating, during vehicle operation, and after operation of the vehicle has ended. The phases can be further separated as well.

In one or more example systems, to determine, based on the violation parameter, the response can include to obtain a phase of an operation of the autonomous vehicle, provided by the mission manager system 506. In one or more example systems, to determine, based on the violation parameter, the response can include to determine, based on the phase, the response. For example, the escalation system 504 may obtain data indicative of the phase of operation of the AV from, e.g., the mission manager system 506.

The phase of an operation of the autonomous vehicle may be used to determine the violation parameter. For example, the escalation system 504 can determine, using the at least one processor, based on the phase, the response. The phase of an operation of the autonomous vehicle may be used to determine whether the sensor data 502 satisfies at least one of one or more criteria. The response may vary depending on the phase of operation of the autonomous vehicle. For example, a violation parameter can be indicative of a passenger having food or drink. For phases of operation including before or during vehicle operation, the response may be a notification to a passenger. For a phase of operation after the ride ends, the response may be to initiate an RCA call to check if there is any spillage in the vehicle.

As another example, a violation parameter can be indicative of too many people in the vehicle. For a phase of operation before vehicle operation, the response may be a notification to a passenger and/or an inability to start the vehicle. However, as new passengers would not enter during movement, and after the ride is over the number of passengers may not matter, there may be no response when the phase of operation indicate that the AV is after the ride or during the ride.

As an example, the response may differ depending on the phase indicating that the vehicle is during operation or ride, as compared to prior to the vehicle operation or ride. For example, a response prior to the vehicle operation may include not being able to start the vehicle. However, this response would not be appropriate if the vehicle was already in operation, such as in motion.

In one or more example systems, to provide the response indicative of the escalation of the policy violation can include to communicate the response to a passenger.

To communicate can include one or more of: to provide, to transmit, to display, to contact, and to present. To communicate can include any providing of the response to the passenger. The communication may be audio and/or visual.

To provide the response indicative of the escalation of the policy violation can include to communicate to an operator, such as an operator of an RCA.

In one or more example systems, the response can include one or more of: an audio response via at least one audio source, and a light response via at least one light source associated with the autonomous vehicle.

For example, an audio response may include the playing of a sound via the autonomous vehicle speakers. The audio response may include playing a sound on a communication device of the passenger. The audio source may be associated with the autonomous vehicle. The audio response may be via a user device of a passenger, causing the user device to emit an audio response.

For example, a light response may include the flashing, such as blinking, turning on and off, and/or changing, such as modifying, of lights within an interior of the autonomous vehicle. The light response may include flashing and/or changing, such as modifying, the headlights of the autonomous vehicle. The light response may include flashing and/or changing, such as modifying, display lights in the autonomous vehicle. The light source may be associated with the autonomous vehicle. For example, the light response may be via a user device of a passenger, causing the user device to emit light response.

In one or more example systems, the response can include a vehicle notification indicator causing a display associated with the autonomous vehicle to display a user interface object indicative of the response.

The user interface object can be indicative of the policy violation and/or a remedy of the policy violation. The response can be displayed on a display of the autonomous vehicle. For example, an autonomous vehicle display can display a warning user interface object. The autonomous vehicle can display the policy that is being violated. The autonomous vehicle can display the necessary response to overcome the policy violation.

In one or more example systems, the response can include a passenger notification indicator to a user device of a passenger.

For example, the notification indicator may cause a user device to display a notification on a display of the user device, such as a mobile telephone. For example, the notification indicator may cause a user device to a notification on a display of the user device. This can include, for example, one or more of: a text message, a push notification, and application notification.

In one or more example systems, the response can include adjusting one or more of: a speed, an acceleration, and a trajectory of the autonomous vehicle.

The adjusting may be seen as, for example, a minimum risk maneuver (MRM).

Multiple different levels of MRM may exist in order to provide nuanced, escalating responses to a wide variety of potential events. Different subsystems may trigger a given MRM. An MRM can include one or more of stopping the autonomous vehicle, slowing down the autonomous vehicle, pulling over the autonomous vehicle.

Adjusting one or more of a speed, an acceleration, and a trajectory of the autonomous vehicle may be a final response. The system 500 may proceed immediately to the adjusting one or more of: a speed, an acceleration, and a trajectory of the autonomous vehicle. The system 500 may proceed to the adjusting one or more of: a speed, an acceleration, and a trajectory of the autonomous vehicle after other responses have been ignored.

Responses can be in response to relatively “minor” policy violations. Initially, after violation of a minor policy, no major action need be taken by the autonomous vehicle if the passenger complies with the policy. However, some policy violations may be construed as “severe” and escalated action can be taken, such as immediately after a violation.

In one or more example systems, adjusting the one or more of: a speed, an acceleration, and a trajectory of the autonomous vehicle can be based on a severity parameter indicative of a severity level of the policy violation.

For example, a violation parameter may include a severity parameter. In accordance with a severity parameter meeting a severity criterion, the severity parameter may be indicative of a high severity. In accordance with a severity parameter not meeting a severity criterion, the severity parameter may be indicative of a low severity.

Different responses may occur based on the severity parameter. For example, a high severity parameter may lead to one response, but a low severity parameter may lead to a different response. For example, a high severity parameter may lead to an escalated response as opposed to a low severity parameter.

The severity parameter may be determined based on the sensor data 502 and the one or more criteria. The severity parameter may be based on whether multiple violation parameters are determined.

For severe passenger policy infringements, responses may range from rerouting to a drop-off zone to pulling over to the side of the road to immediately slowing down and stopping in lane.

As an example, the sensor data 502 may be indicative of a passenger not wearing their seat belt. A determined violation parameter may include a severity parameter which is indicative of a low severity. The escalation system 504 may provide a notification indicating that the passenger should buckle their seatbelt. The notification may be dismissed when it is detected that the policy violation is rectified.

Alternatively, the sensor data 502 may be indicative of a passenger covering one or more components of the CMS. A determined violation parameter may include a severity parameter which is indicative of a high severity. The escalation system 504 may adjust one or more of a speed, an acceleration, and a trajectory of the autonomous vehicle. A notification to the passenger may be skipped, or may be performed in conjunction with the adjusting.

In one or more example systems, in response to determining that, after providing the response, the sensor data 502 satisfies the at least one of the one or more criteria, provide, based on the violation parameter, an escalated response.

In response to determining that, after providing the response, the sensor data 502 does not satisfy the at least one of the one or more criteria, not provide, based on the violation parameter, an escalated response

For example, when the sensor data indicates that a passenger does not rectify a policy violation after a response, the system 500 may be able to continuously escalate the responses. The system 500 may escalate the responses until a final response has been reach, or until the passenger is no longer violating the policy. The system 500 may continuously obtain the sensor data 502 for a determination of whether the sensor data 502 meets one of the one or more criteria.

The escalated response, similar to the response, may be based on the violation parameter. Different violations of policy, as indicated by the violation parameter, can lead to different escalated responses.

The escalated response may provide a more severe action than the action of the response.

The one or more criteria may include whether there is a current violation parameter. For example, a second violation parameter may provide for an escalated response.

The escalation can occur any number of times until a final escalated response is reached. The amount of escalations may vary depending on the type of violation parameter. For example, the response may be escalated 1, 2, 3, 4, or 5 times.

Table I illustrates a non-limiting, example set of violation parameters and responses according to the disclosure.

TABLE I
Examples of Violation Parameters and Responses

| Violation | | | | |
|---|---|---|---|---|
| parameter | | | | |
| indicative | Sensor Data | Response and/or Escalated Response | | |
| of a policy | Obtained | Before start of | During | After |
| violation: | From: | operation | operation | operation |
| Food and | Detection | Notify Passenger | | Initiate |
| drink | using CMS | | | RCA call to |
| | | | | check for |
| | | | | spillage |
| Too many | Expected | Notification indicator | N/A | N/A |
| people in | number of | to passenger; if | | |
| the vehicle | passengers + | escalation system | | |
| | detection | determines there | | |
| | using CMS + | are too many people | | |
| | PODS | in the vehicle after a | | |
| | detection | time threshold, | | |
| | | initiate RCA call | | |
| Not sitting | Pose | N/A | Notification | Initiate |
| upright | detection | | indicator to | RCA call if |
| | using CMS | | passenger | passenger |
| | | | | does not |
| | | | | exit vehicle |
| Seat belt | PODS | Notification indicator | Notification | N/A |
| unbuckled | detection + | to passenger and | indicator to | |
| | seat belt | disable of vehicle | passenger | |
| | sensor | start | | |

| | | | |
|---|---|---|---|
| Hand | Window status + | Notification indicator to | N/A |
| outside | detection using CMS | passenger; if escalation system | |
| window | | determines that the passenger's | |
| | | hand is outside the window after a | |
| | | time threshold, initiate RCA call | |
| Sitting in | PODS | Initiate RCA call immediately and | N/A |
| driver's | detection + | initiate adjusting one or more of a | |
| seat | detection | speed, an acceleration, and a | |
| | using CMS | trajectory of AV (MRM) | |
| Tampering | Blockage | Initiate RCA call immediately, then | N/A |
| with CMS | detection on | RCA can decide whether to adjust | |
| cameras | CMS | one or more of a speed, an | |
| | | acceleration, and a trajectory of | |
| | | AV (MRM) | |
| Tampering | Blockage | Initiate RCA call immediately and | N/A |
| with | detection on | initiate adjusting one or more of a | |
| sensors | sensors | speed, an acceleration, and a | |
| | | trajectory of AV (MRM) | |

In one or more example systems, the system 500 may obtain a passenger rating for each passenger. Each passenger may have a passenger rating. The passenger rating can be indicative of the quality of a passenger, such as how the passenger treats an autonomous vehicle and/or if the passenger has any policy violations. For example, each passenger can have a stored passenger rating, such as a numerical rating. The passenger rating can be stored and/or accessible by the system 500.

The system 500 may be able to modify, such as adjust, the passenger rating for a passenger. For example, if a violation parameter indicative of a policy violation was determined for a passenger, their passenger rating may be lowered. A violation parameter having a high severity is determined, the passenger rating may be lowered more than if a violation parameter having a low severity was determined.

If a violation parameter indicative of a policy violation was not determined for a passenger, their passenger rating may be raised.

In one or more example systems, the system 500 can be configured to provide a response based on the violation parameter and the passenger rating. For example, a passenger having a low passenger rating may experience a different response than a passenger having a high passenger rating.

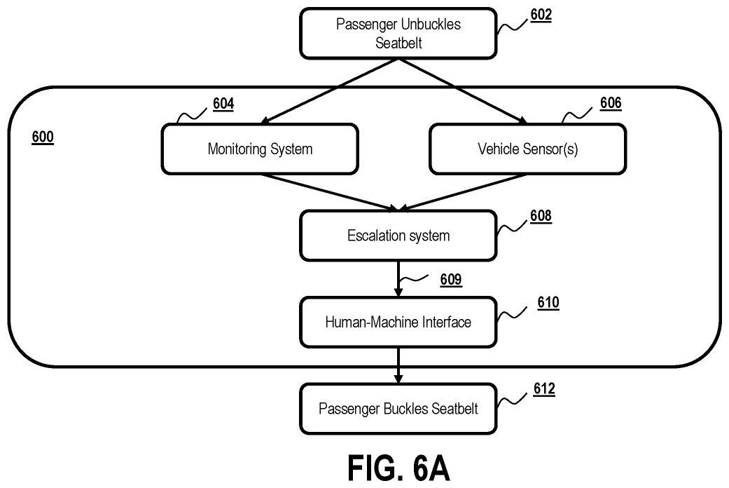

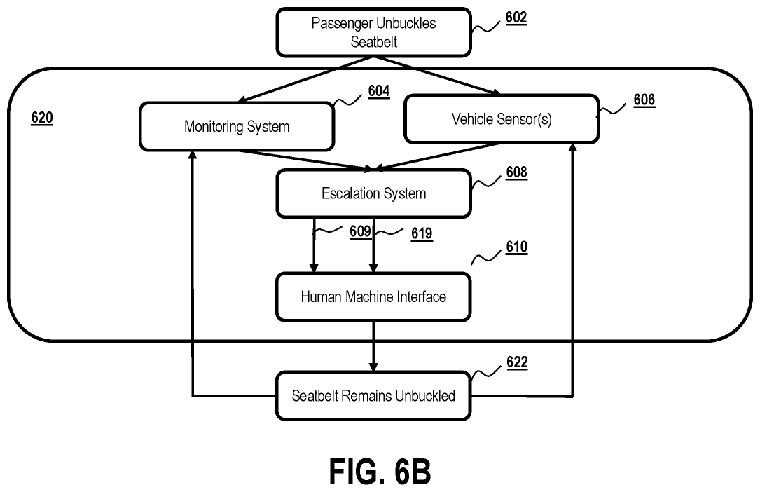

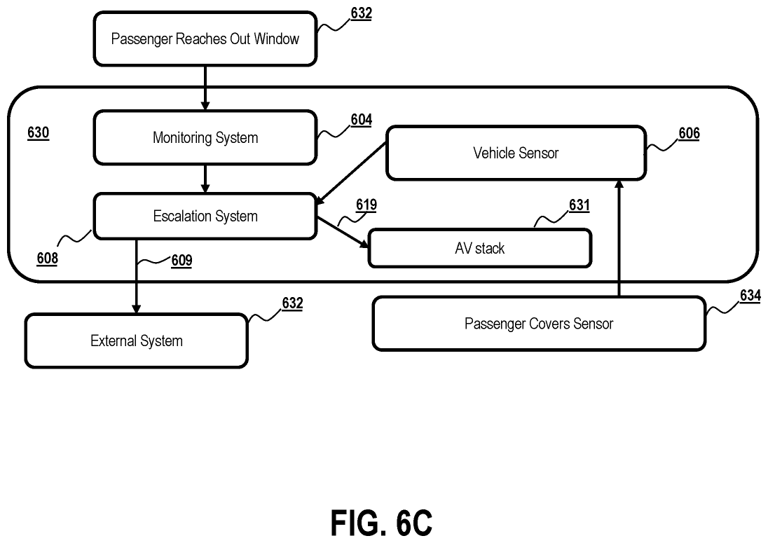

Referring now to FIGS. 6A-6C, illustrated are diagrams of example situation implementations 600, 620, 630 of a process for providing escalation based responses. The implementations 600, 620, 630 can provide for examples of using the implementation 500 discussed with respect to FIG. 5.

FIG. 6A illustrates an example implementation 600, such as system 600. As shown, the passenger may unbuckle 602 his or her seatbelt. This action can be monitored and/captured by one or more of a cabin monitoring system 604 and one or more vehicle sensors 606. For example, the one or more vehicle sensors 606 may be a seatbelt sensor. The cabin monitoring system 604 and/or the one or more vehicle sensors 606 can provide sensor data indicating that the seatbelt for the passenger is unbuckled. The implementation 600 and/or the escalation system 608 can determine whether the sensor data meets one of one or more criteria.

When the sensor data meets one of the one or more criterion, the implementation 600 and/or the escalation system 608 can then determine a violation parameter. The violation parameter can be based on the sensor data. The violation parameter can be indicative of a policy violation. In the situation shown in FIG. 6A, the policy violation is a violation of a passenger being required to wear a seatbelt, and the violation parameter would be indicative of this.

Further, the implementation 600 and/or the escalation system 608 can provide a response 609 indicative of an escalation, for example to a human machine interface (HMI) 610 of the AV. The response 609 can be based on the violation parameter. For example, the autonomous vehicle may, based on the response 609, cause the HMI 610 to display a passenger notification, such as by a flashing light and/or an audio signal. The autonomous vehicle may display a notification to the passenger on a display indicating that the passenger should buckle their seat. The response 609 may be any number of responses, and the particular response is not limiting.

In response to HMI 610 notification, the passenger may buckle 612 their seatbelt. No further action need be taken by the implementation 600, as the sensor data would no longer meet one of the one or more criteria. Further, the HMI 610 notification can be dismissed, such as removed or resolved, automatically.

As shown in FIG. 6A, the escalation of the policy violation may be from taking no action to the response 609. Accordingly, an escalation can be construed as a first response.

FIG. 6B illustrates an example implementation 620. Specifically, FIG. 6B illustrates what happens if a passenger does not comply with a response 609, and an escalation different from that of FIG. 6A.

As shown in FIG. 6B, a similar situation unfolds as was discussed with respect to FIG. 6A. However, in regard to the response 609 provided via the HMI 610, the passenger seatbelt remains 622 unbuckled. Accordingly, the passenger has not responded appropriately to the response 609 to rectify the policy violation. This can be determined, by the escalation system 608, via sensor data, such as again through the cabin monitoring system 604 and/or the one or more vehicle sensors 606 (for example via the feedback loop illustrated). Accordingly, the sensor data can satisfy one of the one or more criteria after the response 609.

The implementation 620 may allow for a particular time threshold to pass before taking any further action. For example, a passenger may have 30 seconds to buckle their seatbelt, though a particular time threshold is not required. Alternatively, or in conjunction, the implementation 520 may obtain sensor data from the monitoring system 604 indicative of a new policy violation, such as the passenger lying down across seats.

Based on the lack of response by the passenger, or the new policy violation, the implementation 620 and/or escalation system 608 can provide, based on the violation parameter, an escalated response 619. The escalated response 619 may be an escalation over the previous response 609, such as a more sever response. The escalated response 619 may be provided to the HMI 610. For example, the escalated response 619 may trigger a call from a remote customer assistance (RCA), such as an agent. The escalated response 619 may trigger an MRM. The escalated response 619 may be a louder audio signal via the HMI 610. Any number of escalated responses 619 can be performed.

FIG. 6C illustrates another example implementation 630. As shown, a passenger may first reach 632 out of a vehicle window. This may be detected via a cabin monitoring system 604. Vehicle sensors may provide confirmation of a window open status. The implementation 630 and/or the escalation system 608 can determine a violation parameter, which can be indicative of the policy violation. In this situation, for example, the policy violation is that a passenger should keep all body parts inside of the autonomous vehicle. The implementation 630 can provide an appropriate response. For example, the response 609 can be a contact by an external system 632, such as RCA. It may be envisaged that the disclosed system is configured to receive a communication from the RCA, for example for giving instructions to the passenger. In one or more embodiments, the disclosed system is configured to receive MRM command from an external system, such as the RCA.

During the RCA communication response, the passenger may cover 634 a sensor of the vehicle. This may be determined via one or more vehicle sensors 606. The implementation 630 and/or the escalation system 608 can determine a second violation parameter. The second violation parameter may be based on the violation parameter, and thus a second response 619 can be provided. The second response 619 can be an escalated response as there is a second policy violation occurring in the autonomous vehicle. The second response 619 may be provided to an AV stack 631 to carry out an MRM.

Referring now to FIG. 7, illustrated is a flowchart of a method or process 700 for providing escalation based responses, such as for operating and/or controlling an AV. The method can be performed by a system disclosed herein, such as an AV compute 400, and a vehicle 102, 200, of FIGS. 1, 2, 3, 4 and the implementation and/or AV compute 540 of FIG. 5, and implementations and/or systems of FIGS. 6A-6C. The system disclosed can include at least one processor which can be configured to carry out one or more of the operations of method 700.

Disclosed herein is a method 700. In one or more example methods, the method 700 can include obtaining such as using at least one processor, sensor data associated with an autonomous vehicle at step 702. In one or more example methods, the method 700 can include determining, such as by using the at least one processor, whether the sensor data satisfies at least one of one or more criteria at step 704. In response to determining that the sensor data satisfies the at least one of the one or more criteria, the method 700 can include determining, such as using the at least one processor, based on the sensor data, a violation parameter indicative of a policy violation of the autonomous vehicle at step 706. In response to determining that the sensor data satisfies the at least one of the one or more criteria, the method 700 can include determining a violation parameter indicative of a policy violation of the autonomous vehicle at step 706. In response to determining that the sensor data satisfies the at least one of the one or more criteria, the method 700 can include providing, such as using the at least one processor, based on the violation parameter, a response indicative of an escalation of the policy violation at step 708. In response to determining that the sensor data satisfies the at least one of the one or more criteria, the method 700 can include providing a response indicative of an escalation of the policy violation at step 708.

In response to determining that the sensor data does not satisfy the at least one of the one or more criteria, the method 700 can include, at step 710, not determining, such as using the at least one processor, based on the sensor data, a violation parameter indicative of a policy violation of the autonomous vehicle. In response to determining that the sensor data does not satisfy the at least one of the one or more criteria, the method 700 can include, at step 710, that the violation parameter indicates that there is no policy violation. In response to determining that the sensor data does not satisfies the at least one of the one or more criteria, the method 700 can include not providing a response indicative of an escalation of the policy violation.

The method 700 can be for operating an autonomous vehicle. The sensor data may include one or more of: optical sensor data, presence sensor data, thermal sensor data, and pressure sensor data. The sensor data can be from one or more sensors. The one or more sensors can include one or more of: PODS sensors, seatbelt sensors, and CMS sensors.

A policy may include one or more operational policies and/or one or more safety policies to ensure operation of the autonomous vehicle and/or integrity of the autonomous vehicle and/or passenger safety, and/or safety around the autonomous vehicle.

The response can be determined by applying a set of rules indicated by the one or more criteria. The escalation may be seen as increasing a level of reaction to policy violation, for example ranging from a notification to a passenger to a more limited operation of the autonomous vehicle. For example, referencing a pre-determined set of rules, the escalation software can determine that this specific violation requires a passenger notification but does not require further escalation or a Minimum Risk Maneuver.

In one or more example methods, the one or more criteria can include a first criterion. The first criterion can be based on a time threshold.

For example, the time threshold may be a threshold of a predetermined length of time after which the escalation software initiates an RCA call due to an extended violation of this specific rule. The escalation software may continue to receive output from the cabin monitoring vision algorithm and seatbelt buckle sensors, and after a predetermined length of time, the escalation software can initiate an RCA call due to an extended violation of this specific rule.

In one or more example methods, the one or more criteria can include a second criterion. The second criterion can be based on a threshold associated with a passenger number.

For example, the threshold associated with the passenger number may be a threshold above which the number of passenger is not authorized.

In one or more example methods, the one or more criteria may include a third criterion. The third criterion can be based on sensor data detecting an event indicative of a tampering of one or more sensors.

For example, tampering can include tampering with internal cameras and/or other sensors.

In one or more example methods, the one or more criteria can include a fourth criterion. The fourth criterion can be based on sensor data detecting a pose indicative of the policy violation of the autonomous vehicle.

For example, a pose may be a predefined pose, such as a pose indicating a passenger not sitting upright.

In one or more example methods, the one or more criteria can include a fifth criterion. The fifth criterion can be based on sensor data detecting a position of a passenger in the autonomous vehicle indicative of a policy violation.

For example, a position may be a predefined position, such as a position indicating a passenger sitting in the driver's seat.

In one or more example methods, at step 708 providing, using the at least one processor, the response indicative of the escalation of the policy violation can include determining, using the at least one processor, based on the sensor data and the violation parameter, the response. Providing the response indicative of the escalation of the policy violation at step 708 can include determining the response.

In one or more example methods, at step 706 determining, using the at least one processor, based on the violation parameter, the response can include obtaining a phase of an operation of the autonomous vehicle. In one or more example methods, at step 706 determining, using the at least one processor, based on the violation parameter, the response can include determining, using the at least one processor, based on the phase, the response.

For example, the phase of the operation of the autonomous vehicle may be seen as a phase in a ride, such as a phase in a mission. For example the phase can indicate a phase before the start of an operation, such as of a ride and/or a mission. For example the phase can indicate a phase during an operation, such as a ride and/or a mission. For example the phase can indicate a phase after an operation, such as a ride and/or a mission. The phase may be a phase of current operation and/or a phase during which the violation occurred.

In one or more example methods, at step 708 providing, using the at least one processor, the response indicative of the escalation of the policy violation can include communicating the response to a passenger.

In one or more example methods, at step 708 providing, using the at least one processor, the response indicative of the escalation of the policy violation can include communicating the response to an operator, such as an operator of an RCA.

In one or more example methods, the response can include one or more of: an audio response via at least one audio source and a light response via at least one light source associated with the autonomous vehicle.

For example, the audio source may be associated with the autonomous vehicle. The audio response may be via a user device of a passenger, causing the user device to emit an audio response.

For example, the light source may be associated with the autonomous vehicle. For example, the light response may be via a user device of a passenger, causing the user device to emit light response.

In one or more example methods, the response may include a vehicle notification indicator causing a display associated with the autonomous vehicle to display a user interface object indicative of the response.

For example, the user interface object can be alternatively, or in conjunction, indicative of the policy violation and/or a remedy of the policy violation. The response can be displayed on a display of the autonomous vehicle.

In one or more example methods, the response can include a passenger notification indicator to a user device of a passenger.

For example, the notification indicator may cause a user device to display a notification on a display of the user device For example, the notification indicator may cause a user device to display a notification on a display of the user device.

In one or more example methods, the response can include adjusting one or more of: a speed, an acceleration, and a trajectory of the autonomous vehicle.

For example, the adjusting may be seen as a minimum risk maneuver (MRM). Multiple different levels of MRM may exist in order to provide nuanced, escalating responses to a wide variety of potential events. Different subsystems may trigger one or more MRMs.

In one or more example methods, adjusting the one or more of: a speed, an acceleration, and a trajectory of the autonomous vehicle can be based on a severity parameter indicative of a severity level of the policy violation.

For example, the severity parameter may be determined based on the sensor data and the one or more criteria. For severe passenger policy infringements, responses may range from rerouting to a drop-off zone to pulling over to the side of the road to immediately slowing down and stopping in lane.

In one or more example methods, the sensor data can include sensor data internal the autonomous vehicle.

In one or more example methods, the sensor data may include sensor data external the autonomous vehicle.

In one or more example methods, the sensor data can be obtained from one or more of: a video-based cabin monitoring system, a seatbelt sensor, pose detection, and a seat occupancy sensor.

In one or more example methods, in response to determining that, after providing the response, the sensor data satisfies the at least one of the one or more criteria, providing, by the at least one processor, based on the violation parameter, an escalated response.

In one or more example methods, in response to determining that, after providing the response, the sensor data does not satisfy the at least one of the one or more criteria, not providing, by the at least one processor, based on the violation parameter, an escalated response.

For example, the escalated response may provide a more severe action than the action of the response.

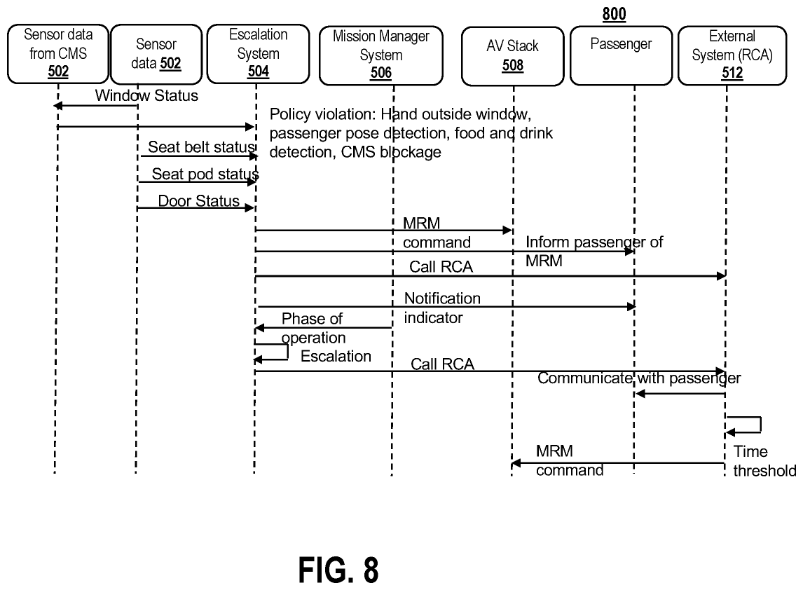

FIG. 8 illustrates a signalling diagram of an example process for providing escalation based responses according to the disclosure.

As shown in FIG. 8, the system 800 could obtain sensor data 502, such as from a CMS or one or more sensors. The sensor data 502 can be used to determine one or more violation parameters indicative of a policy violation of the autonomous vehicle, such as one or more of: a passenger hand outside a window, a passenger in the wrong pose, food or drink detected, and sensor blockage.

The escalation system 504 can provide a response based on the violation parameter. FIG. 8 illustrates a number of different responses that can be taken. For example, the escalation system 504 can provide a command to the AV stack 508 for adjusting one or more of: a speed, an acceleration, and a trajectory of the autonomous vehicle, such as an MRM. The escalation system 504 can provide a response of a notification indicator to a passenger informing them of such an action. The escalation system 504 can provide a response of calling an external system 512, such as an RCA.

Additionally, the phase of an operation of the autonomous vehicle can be determined, and the response may be determined based on the phase.

The escalation system 504 can provide an escalated response as well. For example, if sensor data is not indicative of the passenger rectifying the policy violation, or creating a new policy violation, or if the sensor data is indicative of a policy violation having a severity parameter indicative of a high severity, an escalated response can be provided. An escalated response may be, for example, calling an RCA or adjusting one or more of: a speed, an acceleration, and a trajectory of the autonomous vehicle. Further, the RCA may be able to communicate with the passenger. The RCA may be able to provide the escalated response, such as after waiting a time threshold.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

Also disclosed are methods, non-transitory computer readable media, and systems according to any of the following items:

Item 1. A method, the method comprising:

obtaining, using at least one processor, sensor data associated with an autonomous vehicle;

determining, using the at least one processor, whether the sensor data satisfies at least one of one or more criteria;

in response to determining that the sensor data satisfies the at least one of the one or more criteria:
determining, using the at least one processor, based on the sensor data, a violation parameter indicative of a policy violation of the autonomous vehicle; and
providing, using the at least one processor, based on the violation parameter, a response indicative of an escalation of the policy violation.
   Item 2. Method of Item 1, wherein the one or more criteria comprise a first criterion, wherein the first criterion is based on a time threshold.
   Item 3. Method of any of the previous Items, wherein the one or more criteria comprise a second criterion, wherein the second criterion is based on a threshold associated with a passenger number.
   Item 4. Method of any of the previous Items, wherein the one or more criteria comprise a third criterion, wherein the third criterion is based on sensor data detecting an event indicative of a tampering of one or more sensors.
   Item 5. Method of any of the previous Items, wherein the one or more criteria comprise a fourth criterion, wherein the fourth criterion is based on sensor data detecting a pose indicative of the policy violation of the autonomous vehicle.
   Item 6. Method of any of the previous Items, wherein the one or more criteria comprise a fifth criterion, wherein the fifth criterion is based on sensor data detecting a position of a passenger in the autonomous vehicle indicative of a policy violation.
   Item 7. Method of any of the previous Items, wherein providing, using the at least one processor, the response indicative of the escalation of the policy violation comprises determining, using the at least one processor, based on the sensor data and the violation parameter, the response.
   Item 8. Method of any of the previous Items, wherein determining, using the at least one processor, based on the violation parameter, the response comprises:

obtaining a phase of an operation of the autonomous vehicle; and

determining, using the at least one processor, based on the phase, the response.

Item 9. Method of any of the previous Items, wherein providing, using the at least one processor, the response indicative of the escalation of the policy violation comprises communicating the response to a passenger.
Item 10. Method of any of the previous Items, wherein the response comprises one or more of: an audio response via at least one audio source, and a light response via at least one light source associated with the autonomous vehicle.
Item 11. Method of any of the previous Items, wherein the response comprises a vehicle notification indicator causing a display associated with the autonomous vehicle to display a user interface object indicative of the response.
Item 12. Method of any of the previous Items, wherein the response comprises a passenger notification indicator to a user device of a passenger.
Item 13. Method of any of the previous Items, wherein the response comprises adjusting one or more of: a speed, an acceleration, and a trajectory of the autonomous vehicle.
Item 14. Method of Item 13, wherein adjusting the one or more of: a speed, an acceleration, and a trajectory of the autonomous vehicle is based on a severity parameter indicative of a severity level of the policy violation.
Item 15. Method of any of the previous Items, wherein the sensor data comprises sensor data internal the autonomous vehicle.
Item 16. Method of any of the previous Items, wherein the sensor data comprises sensor data external the autonomous vehicle.
Item 17. Method of any of the previous Items, wherein the sensor data is obtained from one or more of: a video-based cabin monitoring system, a seatbelt sensor, pose detection, and a seat occupancy sensor.
Item 18. Method of any of the previous Items, wherein in response to determining that, after providing the response, the sensor data satisfies the at least one of the one or more criteria:

providing, by the at least one processor, based on the violation parameter, an escalated response.

Item 19. A non-transitory computer readable medium comprising instructions stored thereon that, when executed by at least one processor, cause the at least one processor to carry out operations comprising:

obtaining, using at least one processor, sensor data associated with an autonomous vehicle;

determining, using the at least one processor, whether the sensor data satisfies at least one of one or more criteria;

in response to determining that the sensor data satisfies the at least one of the one or more criteria:
determining, using the at least one processor, based on the sensor data, a violation parameter indicative of a policy violation of the autonomous vehicle; and
providing, using the at least one processor, based on the violation parameter, a response indicative of an escalation of the policy violation.
   Item 20. Non-transitory computer readable medium of Item 19, wherein the one or more criteria comprise a first criterion, wherein the first criterion is based on a time threshold.
   Item 21. Non-transitory computer readable medium of any of Items 19-20, wherein the one or more criteria comprise a second criterion, wherein the second criterion is based on a threshold associated with a passenger number.
   Item 22. Non-transitory computer readable medium of any of Items 19-21, wherein the one or more criteria comprise a third criterion, wherein the third criterion is based on sensor data detecting an event indicative of a tampering of one or more sensors.
   Item 23. Non-transitory computer readable medium of any of Items 19-22, wherein the one or more criteria comprise a fourth criterion, wherein the fourth criterion is based on sensor data detecting a pose indicative of the policy violation of the autonomous vehicle.
   Item 24. Non-transitory computer readable medium of any of Items 19-23, wherein the one or more criteria comprise a fifth criterion, wherein the fifth criterion is based on sensor data detecting a position of a passenger in the autonomous vehicle indicative of a policy violation.
   Item 25. Non-transitory computer readable medium of any of Items 19-24, wherein providing, using the at least one processor, the response indicative of the escalation of the policy violation comprises determining, using the at least one processor, based on the sensor data and the violation parameter, the response.
   Item 26. Non-transitory computer readable medium of any of Items 19-25, wherein determining, using the at least one processor, based on the violation parameter, the response comprises:

obtaining a phase of an operation of the autonomous vehicle; and

determining, using the at least one processor, based on the phase, the response.

Item 27. Non-transitory computer readable medium of any of Items 19-26, wherein providing, using the at least one processor, the response indicative of the escalation of the policy violation comprises communicating the response to a passenger.
Item 28. Non-transitory computer readable medium of any of Items 19-27, wherein the response comprises one or more of: an audio response via at least one audio source, and a light response via at least one light source associated with the autonomous vehicle.
Item 29. Non-transitory computer readable medium of any of Items 19-28, wherein the response comprises a vehicle notification indicator causing a display associated with the autonomous vehicle to display a user interface object indicative of the response.
Item 30. Non-transitory computer readable medium of any of Items 19-29, wherein the response comprises a passenger notification indicator to a user device of a passenger.
Item 31. Non-transitory computer readable medium of any of Items 19-30, wherein the response comprises adjusting one or more of: a speed, an acceleration, and a trajectory of the autonomous vehicle.
Item 32. Non-transitory computer readable medium of Item 31, wherein adjusting the one or more of: a speed, an acceleration, and a trajectory of the autonomous vehicle is based on a severity parameter indicative of a severity level of the policy violation.
Item 33. Non-transitory computer readable medium of any of Items 19-32, wherein the sensor data comprises sensor data internal the autonomous vehicle.
Item 34. Non-transitory computer readable medium of any of Items 19-33, wherein the sensor data comprises sensor data external the autonomous vehicle.
Item 35. Non-transitory computer readable medium of any of Items 19-34, wherein the sensor data is obtained from one or more of: a video-based cabin monitoring system, a seatbelt sensor, pose detection, and a seat occupancy sensor.
Item 36. Non-transitory computer readable medium of any of Items 19-35, wherein in response to determining that, after providing the response, the sensor data satisfies the at least one of the one or more criteria:

providing, by the at least one processor, based on the violation parameter, an escalated response.

Item 37. A system, comprising at least one processor; and at least one memory storing instructions thereon that, when executed by the at least one processor, cause the at least one processor to:

obtain sensor data associated with an autonomous vehicle;

determine whether the sensor data satisfies at least one of one or more criteria;

in response to determining that the sensor data satisfies the at least one of the one or more criteria:

determine, based on the sensor data, a violation parameter indicative of a policy violation of the autonomous vehicle; and

provide, based on the violation parameter, a response indicative of an escalation of the policy violation.

Item 38. System of Item 37, wherein the one or more criteria comprise a first criterion, wherein the first criterion is based on a time threshold.
Item 39. System of any of Items 37-38, wherein the one or more criteria comprise a second criterion, wherein the second criterion is based on a threshold associated with a passenger number.
Item 40. System of any of Items 37-39, wherein the one or more criteria comprise a third criterion, wherein the third criterion is based on sensor data detecting an event indicative of a tampering of one or more sensors.
Item 41. System of any of Items 37-40, wherein the one or more criteria comprise a fourth criterion, wherein the fourth criterion is based on sensor data detecting a pose indicative of the policy violation of the autonomous vehicle.
Item 42. System of any of Items 37-41, wherein the one or more criteria comprise a fifth criterion, wherein the fifth criterion is based on sensor data detecting a position of a passenger in the autonomous vehicle indicative of a policy violation.
Item 43. System of any of Items 37-42, wherein to provide the response indicative of the escalation of the policy violation comprises to determine, based on the sensor data and the violation parameter, the response.
Item 44. System of any of Items 37-43, wherein to determine based on the violation parameter, the response comprises:

to obtain a phase of an operation of the autonomous vehicle; and

to determine, based on the phase, the response.

Item 45. System of any of Items 37-44, wherein to provide the response indicative of the escalation of the policy violation comprises to communicate the response to a passenger.
Item 46. System of any of Items 37-45, wherein the response comprises one or more of: an audio response via at least one audio source, and a light response via at least one light source associated with the autonomous vehicle.
Item 47. System of any of Items 37-46, wherein the response comprises a vehicle notification indicator causing a display associated with the autonomous vehicle to display a user interface object indicative of the response.
Item 48. System of any of Items 37-47, wherein the response comprises a passenger notification indicator to a user device of a passenger.
Item 49. System of any of Items 37-48, wherein the response comprises adjusting one or more of: a speed, an acceleration, and a trajectory of the autonomous vehicle.
Item 50. System of Item 49, wherein adjusting the one or more of: a speed, an acceleration, and a trajectory of the autonomous vehicle is based on a severity parameter indicative of a severity level of the policy violation.
Item 51. System of any of Items 37-50, wherein the sensor data comprises sensor data internal the autonomous vehicle.
Item 52. System of any of Items 37-51, wherein the sensor data comprises sensor data external the autonomous vehicle.
Item 53. System of any of Items 37-52, wherein the sensor data is obtained from one or more of: a video-based cabin monitoring system, a seatbelt sensor, pose detection, and a seat occupancy sensor.
Item 54. System of any of Items 37-53, wherein in response to determining that, after providing the response, the sensor data satisfies the at least one of the one or more criteria:

provide based on the violation parameter, an escalated response.

in response to determining that the sensor data satisfies the at least one of the one or more criteria:
determine based on the sensor data, a violation parameter indicative of a policy violation of the autonomous vehicle; and
provide based on the violation parameter, a response indicative of an escalation of the policy violation.

1. A method, the method comprising:
obtaining, using at least one processor, sensor data associated with an autonomous vehicle;
determining, using the at least one processor, whether the sensor data satisfies at least one of one or more criteria;
in response to determining that the sensor data satisfies the at least one of the one or more criteria:
determining, using the at least one processor, based on the sensor data, a violation parameter indicative of a policy violation of the autonomous vehicle; and
providing, using the at least one processor, based on the violation parameter, a response indicative of an escalation of the policy violation.

2. Method of claim 1, wherein the one or more criteria comprise a first criterion, wherein the first criterion is based on a time threshold.

3. Method of claim 1, wherein the one or more criteria comprise a second criterion, wherein the second criterion is based on a threshold associated with a passenger number.

4. Method of claim 1, wherein the one or more criteria comprise a third criterion, wherein the third criterion is based on sensor data detecting an event indicative of a tampering of one or more sensors.

5. Method of claim 1, wherein the one or more criteria comprise a fourth criterion, wherein the fourth criterion is based on sensor data detecting a pose indicative of the policy violation of the autonomous vehicle.

6. Method of claim 1, wherein the one or more criteria comprise a fifth criterion, wherein the fifth criterion is based on sensor data detecting a position of a passenger in the autonomous vehicle indicative of a policy violation.

7. Method of claim 1, wherein providing, using the at least one processor, the response indicative of the escalation of the policy violation comprises determining, using the at least one processor, based on the sensor data and the violation parameter, the response.

8. Method of claim 1, wherein determining, using the at least one processor, based on the violation parameter, the response comprises:
obtaining a phase of an operation of the autonomous vehicle; and
determining, using the at least one processor, based on the phase, the response.

9. Method of claim 1, wherein providing, using the at least one processor, the response indicative of the escalation of the policy violation comprises communicating the response to a passenger.

10. Method of claim 1, wherein the response comprises one or more of: an audio response via at least one audio source, and a light response via at least one light source associated with the autonomous vehicle.

11. Method of claim 1, wherein the response comprises a vehicle notification indicator causing a display associated with the autonomous vehicle to display a user interface object indicative of the response.

12. Method of claim 1, wherein the response comprises a passenger notification indicator to a user device of a passenger.

13. Method of claim 1, wherein the response comprises adjusting one or more of: a speed, an acceleration, and a trajectory of the autonomous vehicle.

14. Method of claim 13, wherein adjusting the one or more of: a speed, an acceleration, and a trajectory of the autonomous vehicle is based on a severity parameter indicative of a severity level of the policy violation.

15. Method of claim 1, wherein the sensor data comprises sensor data internal the autonomous vehicle.

16. Method of claim 1, wherein the sensor data comprises sensor data external the autonomous vehicle.

17. Method of claim 1, wherein the sensor data is obtained from one or more of: a video-based cabin monitoring system, a seatbelt sensor, pose detection, and a seat occupancy sensor.

18. Method of claim 1, wherein in response to determining that, after providing the response, the sensor data satisfies the at least one of the one or more criteria:
providing, by the at least one processor, based on the violation parameter, an escalated response.

19. A non-transitory computer readable medium comprising instructions
stored thereon that, when executed by at least one processor, cause the at least one processor to carry out operations comprising:
obtaining, using at least one processor, sensor data associated with an autonomous vehicle;
determining, using the at least one processor, whether the sensor data satisfies at least one of one or more criteria;
in response to determining that the sensor data satisfies the at least one of the one or more criteria:
determining, using the at least one processor, based on the sensor data, a violation parameter indicative of a policy violation of the autonomous vehicle; and
providing, using the at least one processor, based on the violation parameter, a response indicative of an escalation of the policy violation.

20. A system, comprising at least one processor; and at least one memory storing instructions thereon that, when executed by the at least one processor, cause the at least one processor to:
obtain sensor data associated with an autonomous vehicle;
determine whether the sensor data satisfies at least one of one or more criteria;
in response to determining that the sensor data satisfies the at least one of the one or more criteria:
determine based on the sensor data, a violation parameter indicative of a policy violation of the autonomous vehicle; and
provide based on the violation parameter, a response indicative of an escalation of the policy violation.
